(19) United States
(12) Patent Application Publication
(10) Pub. No.: US 2017/0262937 A1
(43) Pub. Date: Sep. 14, 2017

(54) FLEXIBLE ACCOUNT MANAGEMENT FOR FINANCIAL ACCOUNT HOLDING FINANCIAL INSTRUMENTS LACKING SALES LOADS

(71) Applicant: Thrivent Financial for Lutherans, Appleton, WI (US)

(72) Inventors: DAVID ROYAL, Orono, MN (US); MICHAEL KREMENAK, Minneapolis, MN (US); KATHRYN STELTER, Osceola, WI (US); JANE SHOLTZ, Hopkins, MN (US); ANDREA TENGBLAD, Holmen, WI (US); LISA SEIFERT, Prescott, WI (US)

(21) Appl. No.: 15/066,885

(22) Filed: Mar. 10, 2016

(51) Int. Cl. G06Q 40/06

(52) U.S. Cl. CPC G06Q 40/06

(57) ABSTRACT

Methods and systems for managing an account are disclosed. One method includes storing account information in a plurality of account records associated with different investors. The account information includes investor information, investment information, and a service option tracking entry independent from the investment information. The investment information includes information regarding a no-load mutual fund. The plurality of account records are managed as part of a database managed by a fund administrator. The method also includes receiving a service option message representing a change in a service level associated with the investor, and, in response to receiving the service option message, determining eligibility of the account associated with the investor based, at least in part, on the investment information. The method includes updating the service option tracking entry to reflect the service level, and triggering an initiation of service according to the service level for the account associated with the investor.

### TECHNICAL FIELD

The present disclosure relates to flexible account management; in particular, the present application relates to flexible account management for financial accounts that hold financial instruments lacking sales loads.

### BACKGROUND

Financial instruments, such as mutual funds, that use brokers to sell their shares typically compensate the brokers who facilitate such sales to investors. Fund managers may do this by imposing a fee on investors, known as a “sales load” (or “sales charge (load)”), which is paid at least in part to the broker-dealer and in part to the sales professional, referred to as a financial representative. There are three general types of sales loads—a front-end sales load investors pay when they purchase fund shares, a back-end or deferred sales load investors pay when they redeem their shares, and a level load investors pay out of fund assets over the period in which they hold such shares. The disadvantage of a front-end sales load is that it reduces the amount available to purchase fund shares. For example, if an investor purchases a fund that has a 5% front-end sales load, in order to invest $10,000 in the fund, the investor must pay $10,500 (i.e., $10,000 purchase at the fund's net asset value per share, plus $500 sales load).

By way of contrast, no-load funds do not charge a sales load to the investor. Such funds may incur other charges, such as a redemption fee, which are typically charged to investors by the fund and which are used to defray expenses incurred by the fund. In addition, distribution fees, commonly referred to as “12b-1 fees” may be paid out of fund assets and are used for marketing, servicing and selling fund assets, for example by paying broker-dealers and financial representatives, paying for advertising, or other similar activities of the fund. Such 12b-1 fees are capped in the amount that can be charged and restricted in the types of activities to which they can be directed. Accordingly, no-load funds typically involve few post-sale services to an investor.

Shares of a fund that include a load, and in particular a front-end load, are generally designated as “Class A” shares, which may charge a 12b-1 Fee of up to 0.25% annually during the life of the fund. By way of contrast, other types of shares of the same fund, such as shares including a contingent deferred sale charge, may impose higher fees during the life of the fund, and may impose a higher sales charge. Such shares may be designated as “Class B” shares. Level load shares of a fund may impose a higher 12b-1 Fees (up to 1.00% annually) over the life of the fund, and may typically be designated as “Class C” shares. Once shares of a specific class are purchased, investors continue to hold the class of shares that was purchased (with small exception for conversion of Class B shares to Class A shares, occurring in some cases once a deferred fee is recouped after a period of time, typically six to eight years).

Most types of no-load funds do not charge 12b-1 fees. For example, institutional shares (or “I shares”) correspond to a share class of mutual funds typically sold to institutional shareholders or to individuals through managed account programs providing investment advisory services and sponsored by a broker-dealer dually registered as a broker-dealer and investment adviser. Such a share class contains no load and does not charge a 12b-1 fee to investors. No-load shares may also be purchased directly from a fund by individuals or institutions through an internet web site from firms such as The Vanguard Group.

In general no-load or low-load mutual funds, particularly I shares, have been seen as attractive investment vehicles for potential investors, because investments in such funds are fully applied to the fund itself. However, during the time in which a fund is held by an investor, that investor's desire for the services of a financial representative may change. For example, an investor may wish to purchase a no-load fund at initial stages of an investment, but may wish to have investment services provided to him/her by a financial representative affiliated with a broker-dealer. Although some services may be provided in association with such no-load or low-load funds, these services are generally limited due to the lack of fees available to support such services. Investors wishing to obtain additional service may be forced to sell their funds and purchase load-bearing funds, thereby incurring load costs (and tax consequences due to realized profit/loss) at inopportune times.

Existing management services for mutual funds and other financial instruments generally store such funds in an account associated with a user. In the case of an institutional account (e.g., associated with an institutional investor, and often including I shares), such accounts lack any facility for charging a service fee, even if liquid funds were available in either the fund account or some other linked account. Rather, whether fees are charged (and whether services are consequently provided) is a function of the identity of the shares (e.g., whether a load exists), and which cannot readily be changed without a purchase/sale of fund shares. Furthermore, there is no ability for a user to opt-in or opt-out of any service features in such accounts, because often there are only limited services available. Accordingly, investors are limited by technological hurdles existing in mutual fund account management structures that are built based on the assumption of existing share types. Improvements in such technological systems to improve, among other aspects, their flexibility, and ease of use, are desirable.

### SUMMARY

In general, the present disclosure relates to improved flexibility regarding account management and services provided to investors in financial instruments such as mutual funds. In example aspects, no-load mutual funds owned by an investor can be stored in an account structure managed by a fund administrator. Such accounts can be configured with configurable service levels and associated service fees, and such configurable service levels are tied to fee withdrawals from a corresponding account owned by the investor.

In a first aspect, a computer-implemented method of managing an account associated with an investor is disclosed. The method includes storing account information in each of a plurality of account records, the plurality of account records corresponding to accounts associated with different investors. The account information includes investor information, investment information, and a service option tracking entry independent from the investment information. The investment information includes information regarding a no-load mutual fund purchased from a financial representative, the plurality of account records being managed as part of a database managed by a fund administrator of the no-load mutual fund. The method includes receiving, from a computer system associated with an investor, a service option message, the service option message representing a change in a service level associated with the account associated with the investor, and, in response to receiving the service option message at a computing system executing an assessment algorithm to determine eligibility of the account associated with the investor to change to the service level identified in the service option message based, at least in part, on the investment information. The method also includes, based on a determination that the account associated with the investor is eligible to change to the service level, updating the service option tracking entry in the account record associated with the investor to reflect the service level. The method includes triggering an initiation of service according to the service level for the account associated with the investor.

In a second aspect, a financial account management system includes an account management server including a processor and a memory communicatively connected to the processor and storing computer-executable instructions which, when executed, cause the memory to execute a method of managing an account associated with an investor. The method includes storing account information in each of a plurality of account records, the plurality of account records corresponding to accounts associated with different investors, the account information including investor information, investment information, and a service option tracking entry independent from the investment information, the investment information including information regarding a no-load mutual fund purchased from a financial representative, the plurality of account records being managed as part of a database stored in the memory and managed by a fund administrator of the no-load mutual fund. The method also includes receiving, from a computer system associated with an investor, a service option message, the service option message representing a change in a service level associated with the account associated with the investor, and in response to receiving the service option message at a computing system executing an assessment algorithm to determine eligibility of the account associated with the investor to change to the service level identified in the service option message based, at least in part, on the investment information. The method also includes, based on a determination that the account associated with the investor is eligible to change to the service level, updating the service option tracking entry in the account record associated with the investor to reflect the service level, and triggering an initiation of service according to the service level for the account associated with the investor.

In a third aspect, a financial account management system is disclosed. The system includes an account management server administered by a fund administrator of a no-load mutual fund, and an account database operatively connected to the account management server, the account database storing account information in each of a plurality of account records, the plurality of account records corresponding to accounts associated with different investors, the account information including investor information, investment information, and a service option tracking entry independent from the investment information, the investment information including information regarding the no-load mutual fund, the plurality of account records being managed by the fund administrator. The service option tracking entry indicates to the account management server a level of service to be provided in association with each account, the service option tracking entry being editable in response to a request received at the account management server from the investor.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example environment in which aspects of the present disclosure can be implemented;

FIG. 2 illustrates a method of managing an account associated with an investor, according to an example embodiment;

FIG. 3 is a schematic illustration of an example computing system in which aspects of the present disclosure can be implemented;

FIG. 4 is a logical illustration of account information tracked in an account database and used to selectively activate a service fee in association with a specific investor; and

FIG. 5 is a transaction diagram illustrating components of the financial network of FIG. 1 used in a purchase or conversion transaction occurring in accordance with the present disclosure.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

As briefly described above, embodiments of the present invention are directed to improved flexibility regarding account management and services provided to investors in financial instruments, such as mutual funds. In example aspects, no-load mutual funds owned by an investor can be stored in an account structure managed by a fund administrator. Such accounts can be configured with configurable service levels and associated service fees, and such configurable service levels are tied to fee withdrawals from a corresponding account owned by the investor. This additional flexibility regarding fund management simplifies tracking of no-load mutual funds and tracking of service fees associated therewith, and allows for improved ease of use by allowing investors to quickly, during the life of the fund, switch between limited and enhanced service offerings, and changing the fees charged from the fund based on such a switch. Additionally, such a service fee-based account allows the investors to flexibly configure the account from which service fees are drawn to draw fees from a different account entirely, despite the fact that such service fees may be calculated based at least in part on the value of the funds held in the account. Such an arrangement minimizes the disruption to a mutual fund account, and allows investors to pair, for example, a money market account or other cash-based account with a fund-holding account in order to accommodate service fees in an integrated investment portfolio managed by a fund administrator. Additional technical advantages regarding simplicity and flexibility of transactions and communication sequences are apparent as well from the below disclosure.

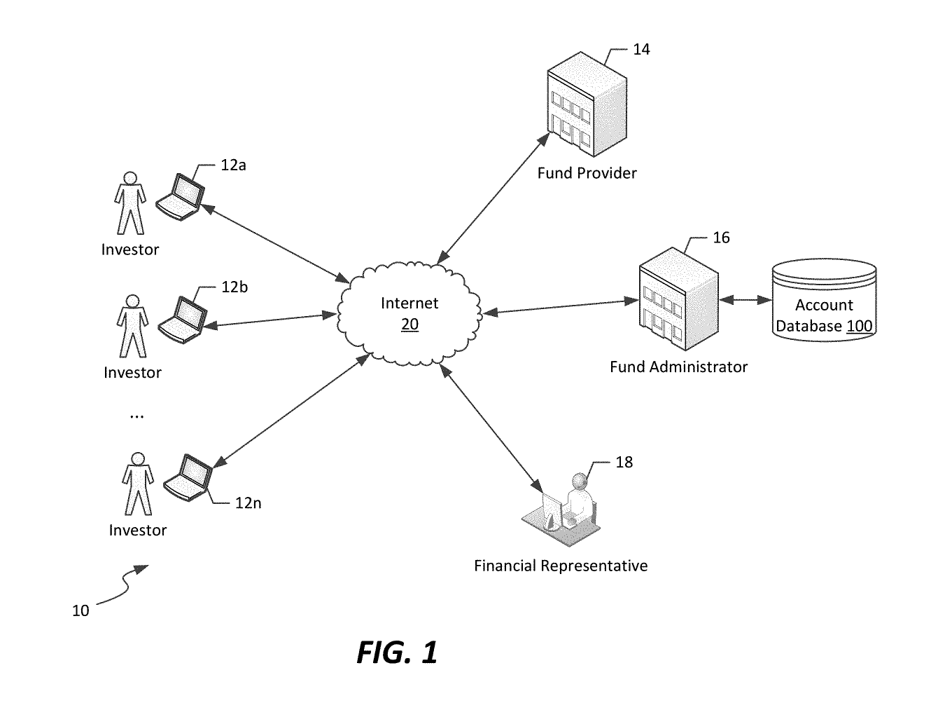

Referring first to FIG. 1, an example schematic illustration of a financial network 10 is provided, in which aspects of the present disclosure can be implemented. The financial network 10 generally corresponds to a network of interested entities relevant to purchase or management of mutual fund holdings by an investor, and associated services provided by an account provider.

In the embodiment shown, the financial network 10 includes a plurality of investors 12a-n (individually and collectively referred to herein as investors 12), a fund provider 14, a fund administrator 16, and a financial representative 18. Each of these entities 12-18 is communicatively interconnected via a network, such as the Internet 20.

The investors 12a-n generally represent account holders or potential account holders who either intend to purchase or who have purchased at least one no-load mutual fund from the fund provider 14. Investors 12a-n can generally represent individuals, institutional investors, or other analogous entities.

The fund provider 14 generally corresponds to the entity offering the fund. In example embodiments, the fund provider represents a broker-dealer who is offering the fund for sale, or can also represent an underlying fund manager. The fund administrator 16 generally corresponds to a clearinghouse entity that manages transactions associated with the fund. In example embodiments, the fund administrator 16 and fund provider 14 can be the same entity; in alternative embodiments, the fund provider 14 can hire a fund administrator to manage fund transactions, such as edits to account information by investors, processing/tracking of fund purchase and sale transactions, calculation of loads and/or service fees, and other transactions associated with a financial account. In addition the fund administrator 16 can store and track information associated not just with the investor, but with a financial representative associated with a purchase of a specific fund. Additionally, the fund administrator 16 is configured to provide periodic reporting to the fund provider 14, such as daily transaction records, messages including corresponding message codes that represent various transaction types, and monthly reports regarding aggregate performance of purchases, sales, and fees associated with a fund.

The financial representative 18 generally corresponds to a third party who may provide advice to a potential investor, as well as other financial planning services that the investor 12 may desire. The financial representative 18 may correspond to a broker licensed to sell the fund offered by the fund provider 14. The financial representative may provide a plurality of services to the investor. Example services can include investment advice services, portfolio analysis services, investment selection services, periodic reporting to the investor, and other investor-oriented services.

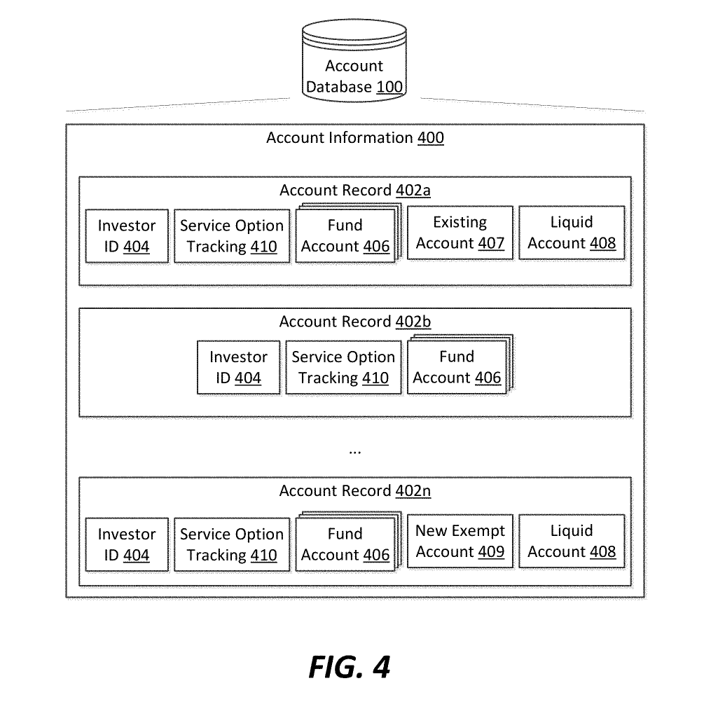

In the embodiment shown, the fund administrator 16 manages an account database 100. The account database 100 stores account information for each of the plurality of investors 12a-n, including accounts storing funds offered by the fund provider 14 as well as funds stored in other types of accounts (e.g., cash accounts, money market accounts, existing load-based mutual fund accounts, etc.). Details regarding an example organization of the account database are described in greater detail below in connection with FIG. 4. Generally, the account database 100 stores a service option identifier, described below, which is editable independently of ownership of any particular fund, but which is calculated based on a value of funds held that are offered by the fund provider. The fund administrator 16 can automatically track a service fee based on a setting of the service option identifier, and based on an algorithm executed to determine that the investor has accounts that are eligible either to include or exclude a service fee, adjust the service option identifier and accordingly change a level of service provided in association with the account. Additional details regarding such an arrangement are discussed below.

It is respectfully noted that although each of the entities 12-18 is represented by a computing system, more than one such computing system may be included at each of these entities, or may be involved in implementing aspects of the present disclosure.

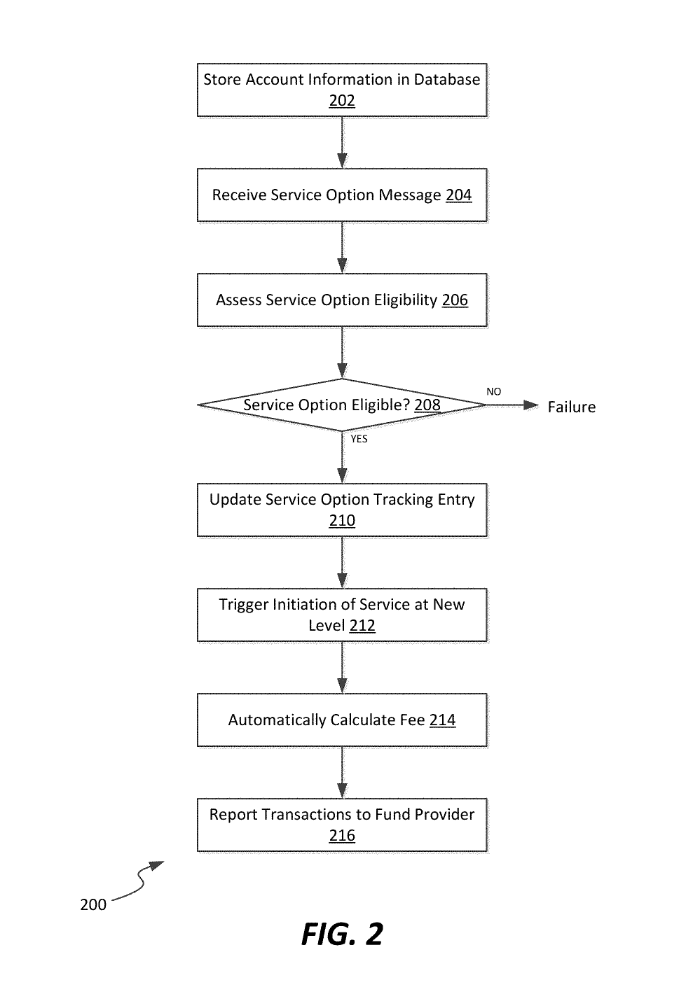

Referring now to FIG. 2, a method 200 of managing an account associated with an investor is shown according to an example embodiment. The method 200 is generally performed by at least one of a fund administrator 16 or fund provider 14, as described above in connection with FIG. 1.

In the embodiment shown, the method 200 includes storing account information in an account database, such as database 100 of FIG. 1 (step 202). The account information stored in the account database can be organized into one or more account records, and corresponds to accounts associated with different investors. In example embodiments, the account information includes investor information (e.g., name, address, contact information, tax information, Social Security number, and other identifying information), as well as investment information. The investment information can include information regarding a no-load mutual fund that was purchased from a financial representative (e.g., financial representative 18). Storing the account information further can include storing a service option tracking entry that is indicative of a current service level associated with the one or more accounts that are tracked n the account information and associated with the investor. The service option tracking entry is, in the embodiment shown, stored independently from the fund information that is maintained in the database, in the sense that the service option tracking entry can be adjusted or changed without any separate requirement that ownership of the no-load fund is affected. In other words, a change may be made to a level of service associated with an investor without requiring a purchase or sale of a fund that is in a different share class and therefore implicates a different level of service typically provided to the investor that owns that fund.

The investment information can also include, in some embodiments information regarding one or more accounts. At least one of the one or more accounts may correspond to an account holding the no-load mutual fund; however, another of the accounts may have different contents, such as mutual funds of a different share class, or may correspond to a cash or money market account. Other types of accounts are useable as well, and may be linked to an investor. Any such linked accounts (including the account holding the no-load mutual fund) may be used for withdrawal of a service fee, which may be computed by a fund administrator at least in part based on an amount of funds invested in the no-load mutual fund.

The method 200 also includes receiving, from a computing system associated with an investor (e.g., any of investors 12a-n), a service option message representing a change in a service level associated with an account of the investor (step 204). Generally, a current service level of the investor may be indicated by the service option tracking entry in the database 100 managed by the fund administrator 16. The service option message is therefore indicative of a change in service level, to change the service level to a higher or lower service level as compared to the current service level. This can include a message indicating to activate enhanced services when such services are not currently activated, or can include a message to opt-out from a service level in which enhanced services are provided. The service option message may be received by the fund administrator from an investor directly, or in alternative embodiments, may be received from a fund provider that receives such a message from an investor. As noted above, such enhanced services may include services that are offered/provided by a financial representative, and may include one or more of investment advice services, portfolio analysis services, investment selection services, periodic reporting to the investor, and other investor-oriented services.

The method 200 includes, in response to receipt of the service option message, executing an assessment algorithm to determine whether the one or more account associated with the investor from which the service option message is received is eligible to change to the service level identified in that message (step 206). The assessment algorithm can be based, for example, on the investment information. In example embodiments, the assessment algorithm includes a determination that the no-load mutual fund is within a share class that is eligible for application of the service fee, and a determination that the investor is not otherwise exempt from such a service fee (e.g., as a current institutional investor, or holder of “I” share class funds). In some cases, the no-load mutual fund has a fund class (referred to herein merely for discussion as “S shares”) corresponding to shares that are typically no-load shares but which are eligible for additional services and which may have an associated increased service fee associated therewith.

Accordingly, the method 200 results in a decision (step 208) regarding whether the service option is one for which the investor is eligible. If the fund accounts associated with the investor do not include an account storing a service option eligible fund, the request to change a service level reflected in the service option message fails. However, if such funds do exist, the method 200 proceeds to update the service option tracking entry in the account database 100 (step 210). This update reflects the service level identified in the service option message, to reflect the service level newly identified by the investor.

In the embodiment shown, the method 200 further includes triggering an initiation of service according to the service level for the account associated with the investor (step 212). This can include, for example, a computer associated with the fund administrator generating a service transaction code that indicates a change in a service level, and transmitting that service transaction code to one or more external entities, such as a fund provider and/or a financial representative. In some such embodiments, the service transaction code is transmitted to the fund provider, who in turn (1) transfers funds to the financial representative to compensate the financial representative for additional services (if the change in service level is an increase in service level), and (2) notifies the financial representative of the higher service level to be provided to the investor. The higher service level can be provided based on services offered by one or both of the fund provider and the financial representative.

In example embodiments, the method 200 includes an automated calculation of a service fee to be charged to an investor given that the investor has opted in to a higher service level (step 214). The calculation of the service fee can, for example, be based on an amount of assets of the investor associated with the specific no-load mutual fund (e.g., the “S share” fund). The specific service fee calculation can be automatically generated based on a fee schedule generally reflecting lower fee rates with higher fund balances. In example embodiments, fee rates may have thresholds of $50,000, $100,000, $250,000, $500,000, and $1M, and decreasing basis point levels to be charged in the range from 85 basis points to 25 basis points.

In example embodiments, the automated calculation of a service fee is further based on a total service fee paid by the investor in association with particular funds during a period of ownership of those funds. In one example (e.g., where an investor has specified an intended length of investment), if an investor has continued in a service fee structure for a period of time in which the investor would be charged an amount approaching a total load of a load-based fund, the automated calculation will lower the calculation of service fees due to ensure that the investor is not charged an amount in excess of the total load incurred in a load-based mutual fund. Accordingly, in example cases, service fees will be less than a load that would otherwise be charged in the event the investor opted into a load-based fund.

In alternative embodiments, after a preset amount of time (e.g., after about 10 years), a service fee will be set at a low flat rate, for example at the low end of the above service fee range (e.g., 25 basis points).

It is noted that the automated calculation of the service fee is based on eligible service fee funds. In other words, the automated calculation of step 214 excludes funds in accounts held by the investor that are not eligible for a service fee calculation, such as an existing money market account, an I Class bond fund, A class share funds, direct sold I class funds, or any other funds that are not part of the service class.

It is noted that the automated service fee calculation described herein can occur on a periodic basis. In example embodiments, service fees will be charged quarterly and based on average daily assets, and assessed without a fee minimum. Other periods, and optional fee minimums, may apply. Furthermore, a fund provider may define with the fund administrator a different period for which a service fee is to be calculated, and service fees may also be calculated in the event of complete liquidation of an S class fund. An ordering of fee application (e.g., applying a service fee withdrawal before other withdrawals may occur) can be provided as well.

In the embodiment shown, the method 200 includes reporting one or more transactions to a fund provider (step 216). Reporting the one or more transactions to the fund provider can include transmitting a daily transaction report to the fund provider identifying purchases and sales of a fund during that time, as well as one or more transaction codes representing service option tracking entries that are selected, reflecting service option messages received by the fund administrator from one or more investors. In further embodiments, other types of reports (e.g., monthly or other periodic reports summarizing all investment activity) can be generated by the fund administrator 16 and provided to a fund provider 14.

It is noted that, irrespective of how the service fee is calculated (if such a service fee applies to a particular investor), the service fee information can be transmitted to the fund provider. This can occur in a variety of ways. In example embodiments, triggering initiation of service at a new service level (step 212) can include performing the automated calculation, and includes notification of the fund provider and/or the financial representative of the applicable service fee. In alternative embodiments, the fee can be reported periodically to the fund provider, alongside reports as noted above.

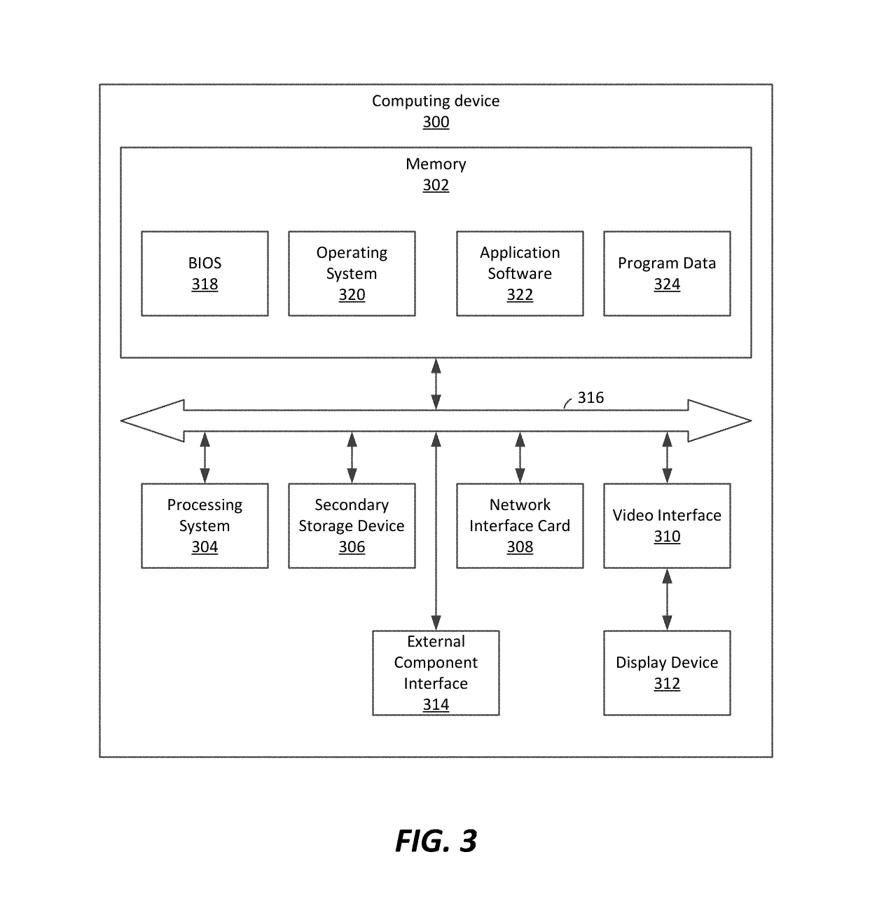

Referring now to FIG. 3, a schematic illustration of an example computing system in which aspects of the present disclosure can be implemented. The computing system 400 can represent, for example, a computing system useable by the entities 12-18 of FIG. 1.

In the example of FIG. 3, the computing device 300 includes a memory 302, a processing system 304, a secondary storage device 306, a network interface card 308, a video interface 310, a display unit 312, an external component interface 314, and a communication medium 316. The memory 302 includes one or more computer storage media capable of storing data and/or instructions. In different embodiments, the memory 302 is implemented in different ways. For example, the memory 302 can be implemented using various types of computer storage media.

The processing system 304 includes one or more processing units. A processing unit is a physical device or article of manufacture comprising one or more integrated circuits that selectively execute software instructions. In various embodiments, the processing system 304 is implemented in various ways. For example, the processing system 304 can be implemented as one or more processing cores. In another example, the processing system 304 can include one or more separate microprocessors. In yet another example embodiment, the processing system 304 can include an application-specific integrated circuit (ASIC) that provides specific functionality. In yet another example, the processing system 304 provides specific functionality by using an ASIC and by executing computer-executable instructions.

The secondary storage device 306 includes one or more computer storage media. The secondary storage device 306 stores data and software instructions not directly accessible by the processing system 304. In other words, the processing system 304 performs an I/O operation to retrieve data and/or software instructions from the secondary storage device 306. In various embodiments, the secondary storage device 306 includes various types of computer storage media. For example, the secondary storage device 306 can include one or more magnetic disks, magnetic tape drives, optical discs, solid state memory devices, and/or other types of computer storage media.

The network interface card 308 enables the computing device 300 to send data to and receive data from a communication network. In different embodiments, the network interface card 308 is implemented in different ways. For example, the network interface card 308 can be implemented as an Ethernet interface, a token-ring network interface, a fiber optic network interface, a wireless network interface (e.g., WiFi, WiMax, etc.), or another type of network interface.

The video interface 310 enables the computing device 300 to output video information to the display unit 312. The display unit 312 can be various types of devices for displaying video information, such as a cathode-ray tube display, an LCD display panel, a plasma screen display panel, a touch-sensitive display panel, an LED screen, or a projector. The video interface 310 can communicate with the display unit 312 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 314 enables the computing device 300 to communicate with external devices. For example, the external component interface 314 can be a USB interface, a FireWire interface, a serial port interface, a parallel port interface, a PS/2 interface, and/or another type of interface that enables the computing device 300 to communicate with external devices. In various embodiments, the external component interface 314 enables the computing device 300 to communicate with various external components, such as external storage devices, input devices, speakers, modems, media player docks, other computing devices, scanners, digital cameras, and fingerprint readers.

The communications medium 316 facilitates communication among the hardware components of the computing device 300. In the example of FIG. 3, the communications medium 316 facilitates communication among the memory 302, the processing system 304, the secondary storage device 306, the network interface card 308, the video interface 310, and the external component interface 314. The communications medium 316 can be implemented in various ways. For example, the communications medium 316 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

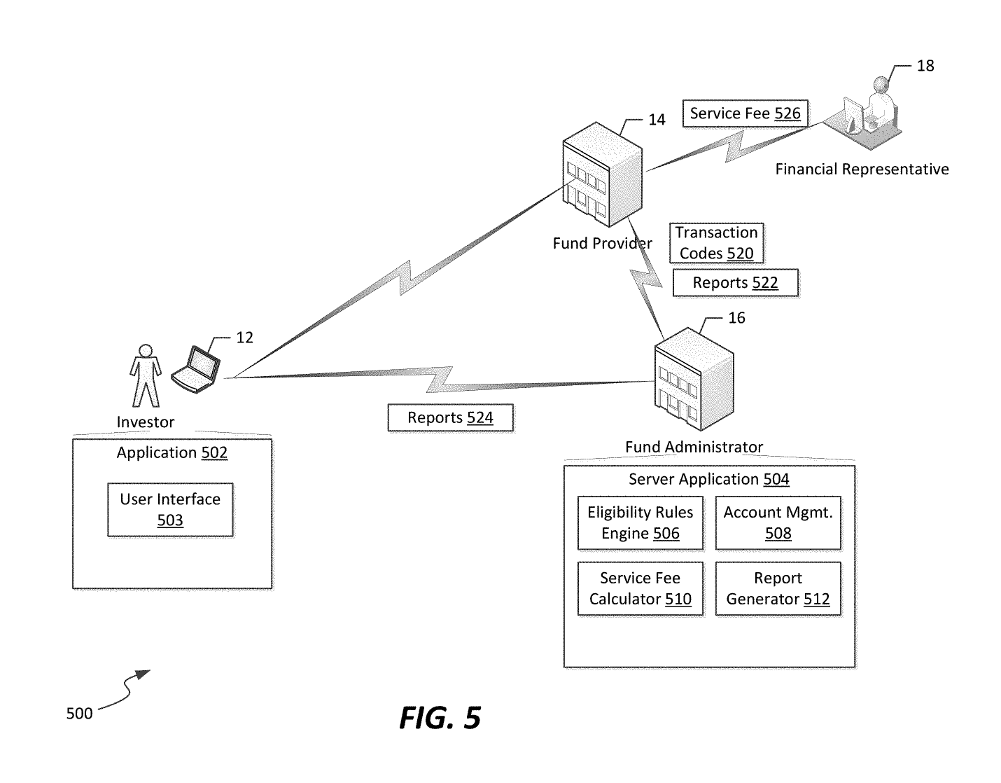

The memory 302 stores various types of data and/or software instructions. For instance, in the example of FIG. 3, the memory 302 stores a Basic Input/Output System (BIOS) 318 and an operating system 320. The BIOS 318 includes a set of computer-executable instructions that, when executed by the processing system 304, cause the computing device 300 to boot up. The operating system 320 includes a set of computer-executable instructions that, when executed by the processing system 304, cause the computing device 300 to provide an operating system that coordinates the activities and sharing of resources of the computing device 300. Furthermore, the memory 302 stores application software 322. The application software 322 includes computer-executable instructions, that when executed by the processing system 304, cause the computing device 300 to provide one or more applications. Example applications are discussed below in connection with FIG. 5. The memory 302 also stores program data 324. The program data 324 is data used by programs that execute on the computing device 300.

Although particular features are discussed herein as included within an electronic computing device 300, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. In specific embodiments, computer storage media comprises non-transitory media. In further embodiments, computer storage media consists entirely of tangible media, such as one or more memory devices as described above.

Referring to FIG. 4, a schematic view of account information 400 stored in a database 100 managed by a fund administrator 14 is shown, according to an example embodiment. The account information 400 stored in the database 100 can be hosted by one or more computing systems of an account administrator 14, including local and cloud-based computing resources.

In the embodiment shown, the account information 400 includes a plurality of account records 402a-n (collectively and individually referred to as account records 402). Each account record 402 includes investor identification information 404, fund account information 406, and a service option tracking entry 410.

The investor identification information 404 can include a variety of information associated with the investor, such as a full name, address, social security number (SSN), and Tax Identification Number (TIN). Other information used to identify the investor can be included as well.

The fund account information 406 corresponds to account information defining a fund account that includes a no-load mutual fund with which service fees may be charged, such as the “S share” funds described herein. It is noted that the fund account information 406 may correspond to one or more accounts; to the extent more than one such account is associated with an investor, service fees may be calculated based on an aggregate value of funds associated with such accounts, and a single service option tracking entry 410 may be associated with all accounts. In alternative embodiments, each account may have a separate service option tracking entry 410 associated therewith.

The service option tracking entry 410 identifies a service level associated with the investor. The service option tracking entry 410 may take a variety of values. In one example embodiment, the service option tracking entry 410 may be assigned a first value (e.g., “Y”) indicating that the fund is subject to a service fee, a second value (e.g., “N”) indicating that the fund is not subject to a service fee because the user has opted out of such a fee, or a third value (e.g., “Z”), indicating that the fund is not subject to the service fee as referring only to accounts for which a service fee is not charged.

In the embodiment shown, each account record 402 is associated with a different investor. Accordingly, the information in each account record will differ, and will be selected based on the preferences and financial holdings of that particular investor. In the embodiment shown, one or more of the account records 402a-n, in this example shown as account record 402a, includes additional account information, such as existing account information 407 and liquid account information 408.

The existing account information 407 corresponds to information regarding an account of an investor that is associated with a preexisting fund purchase of the investor. Such a preexisting fund purchase may be, in some cases, an A share class purchase of a load-based fund, or an I share class purchase of a fund exempt from service fees. As discussed in further detail below, such share classes are not typically included in calculations of service fees. Furthermore, such shares, in particular for A share class funds, may be converted to S class fund shares, such that an overall service fee and level of service may be adjusted to a more flexible arrangement. Details regarding optional conversions of such funds are described below in connection with FIG. 5.

The liquid account information 408 (shown in account records 402a, 402n) corresponds to information describing a further account of the investor that includes liquid (non-fund) assets, such as a money market account, a cash account, an interest-bearing savings account, or other similar accounts. The liquid account information 408 can be tracked, in some cases, in the account record 402, to charge a service fee associated with the fund account(s) 406 of the investor without withdrawing funds from that fund account. In this way, the service fee may be decoupled from the fund account, allowing a full value of the funds invested in the fund account 406 to be applied to investment rather than fees.

It is also noted that, in connection with the fund calculations performed at the fund administrator and as discussed below in connection with FIG. 5, the automated calculation of a service fee may be limited to the fund account 406, and will exclude funds held in either an existing account 407 or a liquid account 408. In specific examples, accounts exempt from such a service fee will include money market funds, limited maturity bond funds (class I), A share funds, direct-sold class I funds, and any other funds that may open in the future that are not part of the service, “S” share class.

Furthermore, in some cases, account information may include an exempt account 409 (e.g., as in account information 402n) which may refer to an institutional account, or I share account, for which service fees are not collected. Accordingly, and as noted in further detail below, such accounts are not included for purposes of service fee calculations. Furthermore, investors in such accounts may continue to invest in I share accounts, even after having such a service fee.

Referring to FIG. 5, a transaction diagram 500 illustrating components of the financial network of FIG. 1 used in a purchase or conversion transaction occurring in accordance with the present disclosure. The transaction diagram 500 illustrates a sequence of electronic message transactions that can be executed to accomplish aspects of the present disclosure relating to management of an account including funds having no loads, but which applies a service fee to such fund accounts based on a preference set by a user.

In the embodiment shown, an investor 12 can communicate with a fund provider 14 or a fund administrator 16 to either purchase or manage a no-load fund in a service fee-based account (e.g., an S share fund, as noted herein). The investor 12 (or alternatively a financial representative 18 or fund provider 14 working in association with such an investor) will use an application 502 to view and access existing and new fund accounts. The application 502 includes a user interface 503 at which accounts, funds, and service fee information can be viewed and edited. In example embodiments, the application 502 can correspond to any of a number of financial management applications or web-based applications, such as a TA2000 Desktop, SmartDesk2, a 3270 LOOKUP facility, FAN Web™, or Vision® software applications.

In some embodiments, the application 502 will be configured to allow a user of that application to indicate in a service fee description an originating fund or account for the fee charged. The application 502 will also allow a user to add a memo transaction to the originating fund or account history when a fee is withdrawn. The application also allows a user to add, update, or delete a payment account designation, and to display the payment account designation. The application 502 can also display payment account changes in a maintenance history, and a display service fee calculation account to payment account cross-reference. Other functionality can be included in the application 502 as well.

A fund administrator 16 executes a server application 504 that manages database 100. The server application includes an eligibility rules engine 506, an account management module 508, a service fee calculator 510, and a report generator 512.

The eligibility rules engine 506 assesses each of the accounts in association with the account records stored in an account database (e.g., database 100 described above), to determine whether the account is eligible to include a service fee type fund, and whether the account can be charged a service fee based on contents of the account record. For accounts that have preexisting funds prior to purchase of a service fee-based fund (e.g., A class and I class shares), a determination of whether a service fee can be charged. In the case of account information describing a preexisting A class fund (e.g., in existing fund information 407), the eligibility rules engine 506 can determine that the fund is eligible for conversion to a S class, no-load fund with an associated service fee. In the case of account information describing a preexisting A class fund, the eligibility rules engine 506 may determine that the user may opt to convert those shares to S class shares without again paying a load on such a fund, (because a further service fee may not be charged based on the total service fee amount would already be reached by the load charged on the A class fund). In the case of I class shares, the eligibility rules engine 506 can determine that at least some types of such shares are exempt from a service fee, and will allow further purchases of such funds but will not enable a user to activate a service fee in association with such funds. Because in some cases I class shares include some services, a separate service level designation may be made in the account information to distinguish such shares from those in which an investor has opted out of services (e.g., the “Z” designation, indicating that the fund is not subject to the service fee as referring only to accounts for which a service fee is not charged).

The account management module 508 manages the database of account records and receives transaction communications from investors 12, financial representatives 18, and a fund provider 14 regarding purchase, sale, service fee changes, personal information edits, or other changes to account information.

In specific embodiments, the account management module 508 allows an investor to set specific settings in association with that investor's account information. For example the account management module 508 manages user preferences (stored in the investor information 404) to define one or more accounts to which a service fee is charged, e.g., a payment account. For example, the payment account may be the account that includes the no-load fund, or may be a different account. In some embodiments, the account management module 508 will allow an investor, via the user interface 503, to select a hierarchy of accounts from which fees are to be withdrawn. For example, if the account information describes not just a funds account 406 but also a liquid account 408, the investor may opt to first withdraw funds from the liquid account and secondarily from the one or more funds accounts 406 that are represented in the account information. In an alternative example, fees would be withdrawn from a designated payment account (e.g., a payment account 406), and only after that funds account is exhausted would the funds account be drawn against. In addition, to the extent the investor has different funds accounts that are service fee accounts, and such accounts have separately-calculated service fees, the investor can define a single payment account, such as liquid account 408, to be the account from which service fees are withdrawn.

In some cases, a set of business rules defined by an investor can be used to assign an appropriate payment account. Such business rules can include identifying a same social code (e.g., a same plan or account type), or a same legal owner. Furthermore, service fees are generally calculated and withdrawn on an oldest-forward basis, especially when such a liquid account is used. In this way, if the liquid account lacks adequate funds to cover all service fees associated with funds accounts 406, services fees will be withdrawn from the youngest purchase lots in any of the accounts associated with the service fee, preserving older lots for which service fee maximums will be reached the soonest. If no account has adequate funds, a report or alert can be automatically generated and sent to the fund provider.

It is noted that one or more of the operations performed by the account management module 508 can be executed by the fund administrator 16 and fund provider 14 based at least in part based on transaction codes 520 that are exchanges with the fund provider 16. For example, a transaction code can be transmitted from the fund administrator to the fund provider 16 that communicates, among other information, fiduciary service fees, non-fiduciary service fees and associated cancellations to facilitate tax reporting and compensation payout to financial representatives 18. This can include, for example, a set of transaction codes included in a daily financial transmission interface package file to provide information regarding financial representative compensation on a daily basis. Additional information can include, in the transaction history, an identity of the financial representative to be compensated, and a state code of the account registration. These transaction codes can be used, for example, for both quarterly fees and mid-quarter fees transmitted to the fund provider 14. In addition, a communication to purchase such a fund may be received by the fund provider 14 from either the investor 12 or from a financial representative 18 working in association with that investor. A communication to adjust a service in association with an existing account may be received from the investor 12 at the fund provider 14, and may be communicated to the fund administrator 16 using one or more transaction codes 520.

In addition to the above transaction codes, a further transaction code may be established that is associated with an external client code, useable for non-taxable exchanges between a fund account 406 and a direct class of funds. This code can be sent alongside other transaction codes, and is useable for exchange between no-fee and fee-based accounts.

The service fee calculator 510 calculates an applicable service fee in association with one or more funds accounts 406 that include eligible funds (e.g., S class no load funds). The calculation can, as noted above, be automatically generated based on a fee schedule generally reflecting lower fee rates with higher fund balances. In example embodiments, fee rates may have thresholds of $50,000, $100,000, $250,000, $500,000, and $1M, and decreasing basis point levels to be charged in the range from 85 basis points to 25 basis points. The service fee calculator 510 can perform such a service fee calculation on a per-account basis or on a per-investor basis, grouping service fee calculations and applicable basis points to be charged across all eligible accounts of that investor.

The report generator 512 generates one or more periodic reports 522 to be transmitted from the fund administrator 16 to the fund provider 14. The report generator 512 can also generate one or more investor reports 524 to be provided to the investor 12.

For example, regarding information provided to the fund provider 14, the report generator 512 will generate fee calculation reports from quarterly fee calculations. The report generator will also generate reports from the daily and quarterly service fee processes that identify accounts for which the fee cannot be collected. In some embodiments, a service fee status field can be included in a daily transmission to the fund provider 14, useable to manage a status of fees. Additional information to be included in such reports includes: average assets used for calculations of service fees, a rate used to calculate the fee, a begin date and an end date for a payment period, a number of days in a payout period, a fee amount calculated for each account, an identity of the financial representative to which the fee is to be paid, an account charged for the service fee, and the assets which were used to derive the fee rate. Other information could be included as well.

Regarding information provided to the investor 12, the report generator 512 will generate an investor statement at least quarterly, including service fees charged and service fee messaging. Such quarterly service fee transactions are generally excluded from daily confirmation reporting to the investor, as these fall under 10b-10 (exception for systematic transactions) and do not need to be separately confirmed. In addition, however, any mid-quarter service fee transactions will be reflected on a confirmation statement in the event of a full liquidation. Such fees may be charged for check, ACH, or wire redemptions.

Referring generally to operation of the systems and methods described herein, it is noted that various investor accounts may be treated differently based on the contents of such accounts or user settings associated with such accounts. For example, investors may arrange a hierarchy of fee withdrawal accounts, using a liquid account (e.g. liquid account 408) as a first option withdrawal account, and one fund account (e.g., fund accounts 406) as secondary option for withdrawal of a service fee if adequate funds do not exist in the liquid account. In still further arrangements, even if all such accounts exist, an investor may be exempt from such a service fee for at least a portion of that investor's funds, for example if that user is determined to have an exempt account (such as exempt account 409 in account record 402n). Other arrangements and variations on the above are possible as well, based on the features and functionality described herein.

Referring generally to FIGS. 1-5, it is noted that various aspects of the present disclosure provide advantages over existing systems in terms of flexibility, automation, and exposure of information to various users. For example, by separating a service fee option tracking entry from any specific fund, a user account can easily be checked to determine if a service fee is to apply, or if it is not to apply, a reason why that fee would not apply. Existing systems would require a check of the types of funds in each account associated with a user to determine if fees are to be charged. Furthermore, because existing fees are inherent in the funds (and share classes) that they are associated with, there is not a requirement for either separate determination of a fee based on a selection of fund accounts, and there is no ability to flexibly charge such a fee to either the account that includes the funds associated with the fee charge or an entirely different account of the investor. Such configuration is generally lacking in existing systems. Furthermore, such a system (i.e., decoupling the service fee from the fund itself) improves technical flexibility by allowing a fund administrator to selectively turn on or off an automated fee for various reasons (e.g., departure of a financial account representative, death of an investor, etc.). In other words, the systems and methods described herein include the ability to expose a switch to an account administrator to turn on/off fees that was not previously available, leading to improved administration flexibility and efficiency (e.g., avoiding moves between load and no-load funds).

In addition, management of migration of existing accounts to such a service fee class of funds provides advantages to a user, and advantages regarding technical complexity. For example, technical complexity of a transition from an A class share to the S class share described herein can be simply performed for investors who closed an A class share account to re-open that account automatically within a pre-set grace period rather than requiring such investors to reapply and pay the up-front commission associated with opening an A class share account.

Still further, because load-based funds are charged a load on a specific schedule, each fund share will have its own preset fees. However, because a service fee is based on an aggregated share value (on a tiered basis), the total service fee that is charged for any given period may vary over the life of an account. For example, a service fee may decline over the life of an account. In some such examples, once a predetermined aggregated amount of service fees have been collected, a service fee amount may reduce to a predetermined level. In some cases the service fee may be capped at predetermined amount, such as an amount not to exceed a load that would otherwise be charged on a fund held within the account, or some other predetermined amount higher or lower than such a load.

In still further embodiments, a fee amount may decrease based on the amount of time the fee is collected, e.g., based on aging of lots included in the investor's account. In such embodiments, fees may continue to be collected over the life of the lots included in the account; however, after a lot has reached a certain age, a service fee percentage may decrease (e.g., to 25 basis points after 10 years from the purchase date).

Accordingly, in view of the complexities of service fee calculations that might be implemented, it may be otherwise difficult to determine whether a total fee charged would exceed fees associated with an A class share. Accordingly, automated calculation of such a service fee, and tracking of an aggregated fee charged to a particular investor, presents advantages regarding simplicity of technical features that are addressed to technical challenges not present in the case of A class shares. Additional advantages are apparent as well from the above description.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

The above specification, examples and data provide a complete description of the manufacture and use of the composition of the invention. Since many embodiments of the invention can be made without departing from the spirit and scope of the invention, the invention resides in the claims hereinafter appended.

1. A computer-implemented method of managing an account associated with an investor, the method comprising:
storing account information in each of a plurality of account records, the plurality of account records corresponding to accounts associated with different investors, the account information including investor information, investment information, and a service option tracking entry independent from the investment information, the investment information including information regarding a no-load mutual fund purchased from a financial representative, the plurality of account records being managed as part of a database managed by a fund administrator of the no-load mutual fund;
receiving, from a computer system associated with an investor, a service option message, the service option message representing a change in a service level associated with the account associated with the investor;
in response to receiving the service option message at a computing system executing an assessment algorithm to determine eligibility of the account associated with the investor to change to the service level identified in the service option message based, at least in part, on the investment information;
based on a determination that the account associated with the investor is eligible to change to the service level, updating the service option tracking entry in the account record associated with the investor to reflect the service level; and
triggering an initiation of service according to the service level for the account associated with the investor.

2. The computer-implemented method of claim 1, wherein the service comprises a higher service level than an initial service level of the account associated with the investor.

3. The computer-implemented method of claim 2, further comprising automatically charging a service fee to the investor upon initiation of service according to the service level.

4. The computer-implemented method of claim 3, wherein charging the fee comprises withdrawing funds from an account of the investor in an amount equal to the fee.

5. The computer-implemented method of claim 4, wherein withdrawing funds from the account of the investor comprises withdrawing funds from the account including the no-load mutual fund.

6. The computer-implemented method of claim 4, wherein withdrawing funds from the account comprises withdrawing funds from a cash account of the investor that is separate from the account including the no-load mutual fund.

7. The computer-implemented method of claim 4, wherein withdrawing funds from the account comprises withdrawing funds from a money market account.

8. The computer-implemented method of claim 1, wherein the service option tracking entry is changeable without changing a share class of the no-load mutual fund.

9. The computer-implemented method of claim 1, wherein the service comprises a lower service level than an initial service level of the account associated with the investor.

10. The computer-implemented method of claim 1, further comprising:
automatically charging a service fee to at least one investor of the plurality of investors;
automatically monitoring each of the plurality of account records to determine whether a lot has reached a particular threshold; and
based on a determination that the lot has reached the threshold, reducing the service fee charged to the at least one investor in association with the lot.

11. The computer-implemented method of claim 1, wherein the service comprises assisting the investor in selecting a no-load mutual fund in which to invest.

12. A financial account management system comprising:
an account management server including:
a processor;
a memory communicatively connected to the processor and storing computer-executable instructions which, when executed, cause the memory to execute a method of managing an account associated with an investor, the method comprising:
storing account information in each of a plurality of account records, the plurality of account records corresponding to accounts associated with different investors, the account information including investor information, investment information, and a service option tracking entry independent from the investment information, the investment information including information regarding a no-load mutual fund purchased from a financial representative, the plurality of account records being managed as part of a database stored in the memory and managed by a fund administrator of the no-load mutual fund;
receiving, from a computer system associated with an investor, a service option message, the service option message representing a change in a service level associated with the account associated with the investor;
in response to receiving the service option message at a computing system executing an assessment algorithm to determine eligibility of the account associated with the investor to change to the service level identified in the service option message based, at least in part, on the investment information;
based on a determination that the account associated with the investor is eligible to change to the service level, updating the service option tracking entry in the account record associated with the investor to reflect the service level; and
triggering an initiation of service according to the service level for the account associated with the investor.

13. The financial account management system of claim 12, wherein the account information includes information regarding a plurality of accounts associated with the investor including the account holding the no-load mutual fund, wherein the method further comprises deducting a service fee from another of the plurality of accounts associated with the user based at least in part on the amount of funds invested in the no-load mutual fund.

14. The financial account management system of claim 13, wherein the method further comprises automatically calculating the service fee at the account management server.

15. The financial account management system of claim 14, wherein the method further comprises receiving from the investor a designation of an account from among a plurality of accounts associated with the user from which the service fee is to be deducted.

16. The financial account management system of claim 12, wherein the method further comprises:
issuing a service fee transaction code to the fund administrator associated with each account for which a service fee is to be charged;
issuing a report to the fund administrator, the report including an identification of a service fee to be charged, a financial representative to be compensated in response to collection of the fee, and a state code identifying a state of account registration.

17. A financial account management system comprising:
an account management server administered by a fund administrator of a no-load mutual fund;
an account database operatively connected to the account management server, the account database storing account information in each of a plurality of account records, the plurality of account records corresponding to accounts associated with different investors, the account information including investor information, investment information, and a service option tracking entry independent from the investment information, the investment information including information regarding the no-load mutual fund, the plurality of account records being managed by the fund administrator;
wherein the service option tracking entry indicates to the account management server a level of service to be provided in association with each account, the service option tracking entry being editable in response to a request received at the account management server from the investor.

18. The financial account management system of claim 17, wherein the account information includes investor name information, a broker identification number, a tax identification number, and a discount number.

19. The financial account management system of claim 16, wherein the account database is hosted by a computing system communicatively connected to the account management server.

20. The financial account management system of claim 16, wherein the service includes telephone-based investment advice services.
